(19) United States
(12) Patent Application Publication
(10) Pub. No.: US 2003/0205953 A1
(43) Pub. Date: Nov. 6, 2003

(54) Electromagnetic locking system for cabinet doors and drawers

(76) Inventor: Robert N. Fox, Smyrna, GA (US)

Correspondence Address: ROBERT N. FOX, 3622 WISTERIA LANE SE, SMYRNA, GA, 30082, US

(21) Appl. No.: 10/425,174

(22) Filed: Apr. 29, 2003

Related U.S. Application Data
(60) Provisional application No. 60/376,692, filed on May 1, 2002.

(51) Int. Cl. E05C 9/10; E05B 65/46

(52) U.S. Cl. 312/216

(57) ABSTRACT

An electromagnetic locking system for cabinet doors and drawers having a single actuator which turns on and off a power supply which in turn turns on and off a plurality of locking assemblies. The locking assemblies are attached to the framework of the openings for an existing cabinet's doors and/or drawers. Each locking assembly has a matching armature plate attached to the corresponding door or drawer for each particular opening. When turned on, the locking assemblies generate an electromagnetic field that attract their matching armature plates and secure them against the locking assemblies thereby securing and locking the door or drawer against the cabinet framework restricting access into the cabinet. The door or drawer is held locked against the cabinet framework until the power supply is turned off by the actuator, at which point the electromagnetic field between the locking assemblies and the armature plates is de-energized, thereby unlocking the cabinet doors or drawers and allowing access into the cabinet.

### CROSS REFERENCE TO RELATED APPLICATIONS

This application is entitled to the benefit of Provisional Patent Application Ser. No. 60/376,692, filed May 1, 2002.

### BACKGROUND

1. Field of Invention

This invention generally relates to latching or locking devices. More particularly, the present invention relates to safety latching or locking devices for securing cabinets or drawers against access by children.

2. Description of Prior Art

Latching devices are commonly used for securing cabinets, drawers and other closure devices in a closed and latched position. Such latching devices typically have been in the form of keyed locks mounted in the door or face of a drawer and include a locking bolt that is moved into locking engagement with the frame of the door or drawer as the key is turned. Such keyed locks are, however, not practical or are inconvenient for use with drawers or cabinets that are frequently accessed, such as kitchen cabinets, such that it is impractical to have to replace/use a key to open the drawer or cabinet. However, it is often necessary for these cabinets to be secured against access by small children to prevent them from reaching dangerous or breakable objects such as knives or glassware.

Accordingly, childproof latching or locking devices have been developed to secure drawers and cabinet doors. For example, U.S. Pat. Nos. 4,139,249, 5,795,044 and 5,823,649 disclose child-proof latches for cabinets and drawers. The problem with such child-proof latching devices, however, typically has been that they are difficult to operate, as they generally include a spring biased catch or lock located inside the cabinet or drawer. Thus, the person operating the drawer or cabinet generally must hold the door or drawer open with one hand while reaching into the drawer and depressing the catch with the other hand. In addition, the need to partially open the cabinet or drawer in order to disengage the catch allows room for small hands or fingers to reach in and get smashed, therefore increasing the possibility of injury. Also, only one cabinet or drawer can be accessed at a time since both hands are required to unlock any such cabinets or drawers; cabinet doors and drawers must be unlocked one at a time. In addition, once many of these latches are installed, they must be locked each time the door or drawer is closed, and unlocked each time access into a cabinet is desire, regardless of whether or not such locking and unlocking is wanted or needed.

Still, other devices, such as those disclosed in U.S. Pat. Nos. 6,431,616 and 5,188,405 try to improve on the concept of child-proofing cabinets and drawers, yet posses their own disadvantages. These devices can damage the frame and face of the cabinet through wear and tear, and their installation require modification of the cabinets with procedures that call for drilling into and/or through the cabinet doors or drawers. Special hardware “keys” are required to operate such devices, and the process of aligning these “keys” also increase the possibility of damaging the cabinet or drawer faces. Furthermore, these devices do not overcome the aforementioned disadvantage of having to unlock cabinet doors and drawers one at a time.

Finally, U.S. Pat. No. 5,360,243 discloses a device that uses an electromagnetic member to unlock cabinet doors or drawer equipped with such a device. The disadvantage with such a device is that it is comprised of multiple moving parts and that the electromagnetic force generated by the electromagnetic member is used to counteract the spring loaded force that keeps the latch securely in placed and the door or drawer locked. This means that the electromagnetic force is used to disengage the lock and unlock the cabinet door, and if the system fails, the spring-loaded lock will remain in place with no means of opening the door or drawer. This device also requires extensive wiring, could damage the cabinet frame through wear and tear, and still can only open one door or drawer at a time.

### SUMMARY

In accordance with the present invention, an electromagnetic locking system for cabinet doors and drawers comprises a single actuator, a power supply turned on and off by the actuator, a plurality of locking assemblies and their matching armature plates attached to a cabinet's framework and to the cabinet's doors and drawers, a connection between the power supply and the locking assemblies, and a way of attaching the locking assemblies and armature plates to the cabinet's framework, doors, and drawers.

Objects and Advantages

Accordingly, several objects and advantages of the present invention are:

(a) to provide a cabinet door and drawer locking system which allows for the simultaneous locking and unlocking multiple doors and drawers with a single actuator;

(b) to provide a cabinet door and drawer locking system which controls the locking and unlocking of all doors and drawers from a single remote actuator;

(c) to provide a cabinet door and drawer locking system which by design does not allow even the partial opening of any cabinet door or drawer when in the locked position;

(d) to provide a cabinet door and drawer locking system that utilizes electromagnetic force instead of mechanical force to keep cabinet doors and drawers locked;

(e) to provide a cabinet door and drawer locking system which has no moving parts

(f) to provide a cabinet door and drawer locking system that is easy to install with no modifications to the existing cabinet framework;

(g) to provide a cabinet door and drawer locking system that by its versatility can be installed and fitted onto virtually all types of cabinets

(h) to provide a cabinet door and drawer locking system which eliminates wear and tear damage to cabinet doors, drawers, and framework.

Further objects, features, and advantages of the present invention will become apparent to those skilled in the art upon reading the following specification, when taken in conjunction with the accompanying drawings.

### DRAWING FIGURES

FIG. 1 shows a perspective view of a cabinet assembly with cutaways to show location of invention components.

FIG. 2 shows an exploded view of an electromagnetic door-lock assembly for a cabinet door plus an armature plate to show the relationship of their alignment according to FIG. 1.

FIG. 3 shows an exploded view of an electromagnetic drawer-lock assembly for a cabinet drawer plus an armature plate to show the relationship of their alignment according to FIG. 1.

### REFERENCE NUMERALS IN DRAWINGS

| | |
|---|---|
| 10 | cabinet assembly |
| 11 | remote transmitter |
| 12 | power supply |
| 13 | front cabinet frame |
| 14A | drawer |
| 14B | drawer backboard |
| 15 | cabinet door |
| 16A | electromagnetic door-lock assembly |
| 16B | electromagnetic drawer-lock assembly |
| 17 | cabinet side panel |
| 20 | electromagnetic core |
| 21 | wire |
| 22 | base |
| 23 | wood screw |
| 24 | clamp |
| 25A | armature door-plate |
| 25B | armature drawer-plate |
| 26 | plate screw |
| 30 | angle bracket |
| 31A | bracket screw |
| 31B | bracket nut |

### DESCRIPTION

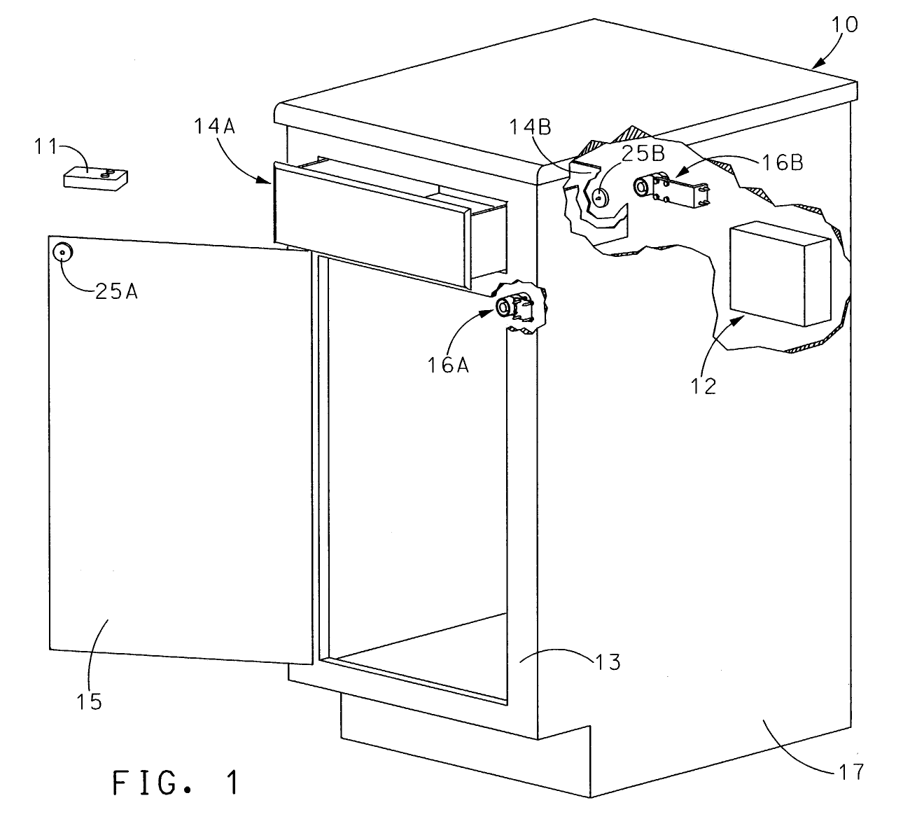

### FIGS. 1, 2, and 3 Preferred Embodiment

A preferred embodiment of the present invention is illustrated in FIGS. 1, 2, and 3. In the form of the construction shown, which is by way of example only, the locking and unlocking of cabinet doors and drawers are under the control of an adult by way of a remote transmitter. The electromagnetic locking system may be installed in a plurality of existing cabinet doors and drawers so that all cabinet doors and drawers may be locked and unlocked simultaneously. Since cabinets are all of substantially the same construction, only one need be described in detail. The mounting positions and locations described below are for illustration purposes only and do not imply that installation of the locking system's components is limited to these positions and locations.

A cabinet assembly 10 has two (2) openings in its front cabinet frame 13: an opening for a cabinet door 15 and an opening for a drawer 14A. An electromagnetic door-lock assembly 16A is attached onto front cabinet frame 13 at the opening for cabinet door 15, and an electromagnetic drawer-lock assembly 16B is attached onto a cabinet side panel 17 at a location behind the closed drawer 14A. A metal armature-plate 25A is attached to the inside of cabinet door 15 and a metal armature drawer-plate 25B is attached to the backside of drawer 14A's drawer backboard 14B.

Mounted in a protected position—in this case, inside the enclosed cabinet assembly 10 is a remote controlled electric power supply 12, which provides each of the electromagnetic lock assemblies 16A and 16B with current. A single power supply 12 can provide power for up to thirty (30) electromagnetic cores 20, all thirty (30) turning on and off at the same time. Power supply 12 is plugged into a standard electrical household outlet and is turned on and off by use of a remote transmitter 11.

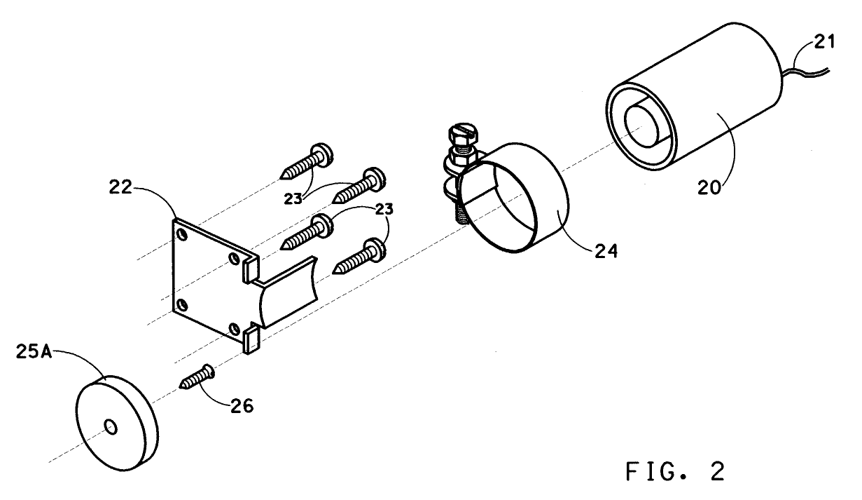

As shown in FIG. 2, electromagnetic door-lock assembly 16A consists of a base 22 attached to front cabinet frame 13 with four wood screws 23. An electromagnetic core 20 is fastened securely onto base 22's rounded protruding edge by means of a clamp 24. A wire 21 connecting electromagnetic core 20 to power supply 12 provides current to electromagnetic core 20. FIG. 2 also shows how armature door-plate 25A aligns with electromagnetic core 20. However, armature door-plate 25A is not part of electromagnetic door-lock assembly 16A since it is attached to the inside of cabinet door 15 with a plate screw 26, as shown in FIG. 1. Nonetheless, armature door-plate 25A is shown in FIG. 2 to illustrate the alignment between electromagnetic core 20 and door-plate 25A.

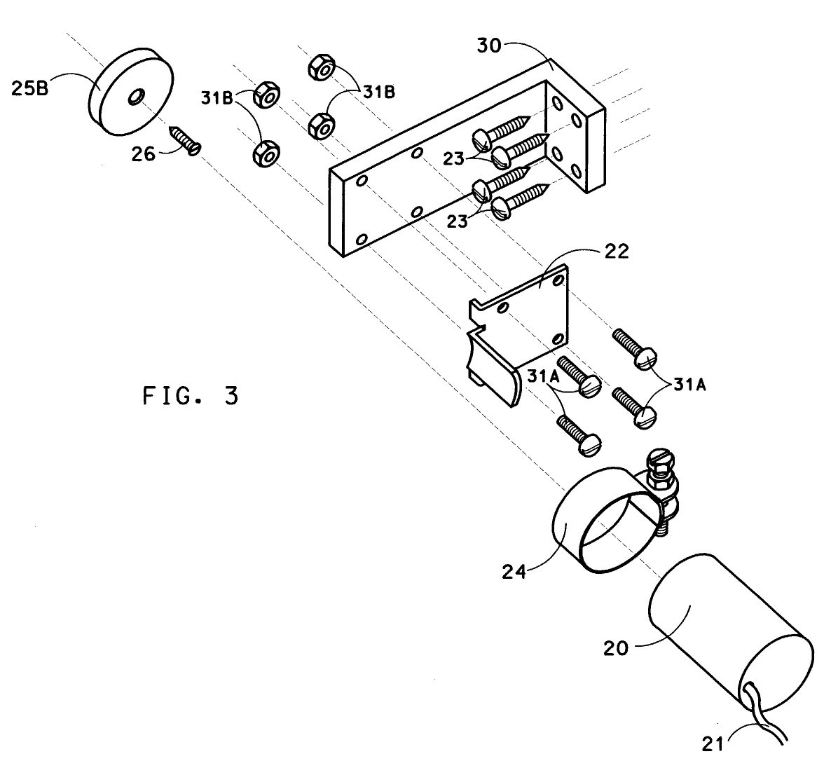

As shown in FIG. 3, electromagnetic drawer-lock assembly 16B consists of a base 22 attached to an angle bracket 30 with four bracket screws 31A and four bracket nuts 31B. Angle bracket 30 is itself attached to a cabinet side panel 17 with four wood screws 23. An electromagnetic core 20 is fastened securely onto base 22's rounded protruding edge by means of a clamp 24. A wire 21 connecting electromagnetic core 20 to power supply 12 provides current to electromagnetic core 20. FIG. 3 also shows how armature drawer-plate 25B aligns with electromagnetic core 20. However, armature drawer-plate 25B is not part of lock assembly 16B since it is attached to the outside of drawer backboard 14B with a plate screw 26, as shown in FIG. 1. Nonetheless, armature drawer-plate 25B is shown in FIG. 3 to illustrate the alignment between electromagnetic core 20 and drawer-plate 25B.

It should be noted that electromagnetic door-lock assembly 16A and electromagnetic drawer-lock assembly 16B are essentially put together from identical components. The main difference between the two lock assemblies is the addition of angle bracket 30 plus bracket screws 31A and bracket nuts 31B to electromagnetic drawer-lock assembly 16B. This being the case, no distinction is made between the identical components seen FIGS. 2 and 3 where the identical components serve the same function in both Figures.

Alternative Embodiments

There are several possibilities with regard to the mounting of the electromagnetic lock assemblies 16A and 16B and their matching armature plates 25A and 25B. Depending on the specific construction of pre-existing cabinet assemblies, it might be necessary to fasten electromagnetic lock assembly 16A and 16B and their matching armature plates 25A and 25B onto different locations than those shown in FIG. 1. This applies to both cabinet doors and cabinet drawers. Still, the end result is the same, and the alignments shown in FIGS. 2 and 3 will be preserved thus maintaining the integrity of the design.

Power supply 12 could also be installed in a location other than that shown in FIG. 1. Positioning power supply 12 in any location where it will be protected from tampering would suffice to maintain the integrity of the design. In addition to having power supply 12 plugged directly into a standard household electrical outlet, it can be connected to or fitted with a battery backup to ensure the electromagnetic locking system will work in the event of a power outage.

There are also several possibilities with regard to what the electromagnetic locking system uses as its actuator to turn on and off power supply 12. Instead of using remote transmitter 11, a wired on-off switch or button can be installed in the vicinity to the cabinets or drawers fitted with the electromagnetic locking system. Also, a timer, a card reader, or a numeric lock pad could be installed to regulate access into the cabinets or drawers.

Advantages

From the description above, a number of advantages of my electromagnetic locking system for cabinet doors and drawers become evident:

(a) All cabinet doors and drawers in a kitchen can be the simultaneously locked and unlocked with a single actuator without the need to physically go to each individual door or drawer.

(b) The use of the remote control eliminates the need to engage or disengage each cabinet door and drawer lock manually.

(c) The on-off capability of the system allows for the user to decide when all cabinets are locked or unlocked. This means that installing the system does not force the user to lock and unlock the doors and drawers each time access into the cabinets is desired or gained. If children are not present in the kitchen, all cabinet doors and drawers can remain unlocked and accessible until the next time a safety risk detected. Then, only when needed, all the cabinets can be locked and secured.

(d) The risk of injury to hands or fingers caught or smashed in partially opened doors or drawers is eliminated.

(e) The use electromagnetic force instead of mechanical force to keep cabinet doors and drawers locked allows for a system with no moving parts. In the event of a system or power failure, the absence of moving parts eliminates the risk of locked and inaccessible doors and drawers caused by unresponsive electrical spring-loaded locks.

(f) The ease of installation requires no modifications of existing cabinet framework.

(g) The system's versatility allows it to be installed and fitted onto virtually all types of cabinets.

(h) Since all mating and contact of parts required for locking and unlocking happens between the system's installed components and not between the components and the cabinet doors, drawers, or framework, wear and tear damage to cabinets is eliminated.

Operation—FIGS. 1 and 2

The electromagnetic locking system uses electromagnets to keep cabinet door 15 and drawer 14A closed and locked to prevent access to their contents. As seen in FIGS. 1, 2, and 3, electromagnetic cores 20 are mounted onto cabinet assembly 10's framework. For the electromagnetic core 20 mounted onto the cabinet framework corresponding to cabinet door 15, one matching armature door-plate 25A is mounted onto cabinet door 15. For the electromagnetic core 20 mounted onto the cabinet framework corresponding to drawer 14A, one matching armature drawer-plate 25B is mounted onto drawer backboard 14B. Armature door-plate 25A is attached with a single flat-head plate screw 26 onto the inside face of cabinet door 15; likewise, armature drawer-plate 25B is attached with a single flat-head plate screw 26 onto the onto the backside of drawer 14A's drawer backboard 14B. With cabinet door 15 and drawer 14A closed, armature door-plate 25A and armature drawer-plate 25B are aligned and in contact with their respective electromagnetic cores 20. Using remote transmitter 11 to turn the system on, a signal is sent to the remote controlled power supply 12 which in turn sends an electric current to electromagnetic cores 20. When the electric current is applied to electromagnetic cores 20, a magnetic field is created within each core that attracts their corresponding armature plates (armature-door plate 25A or armature drawer-plate 25B). The magnetic field keeps armature door-plate 25A and armature drawer-plate 25B from separating from their respective electromagnetic cores 20 and holds them firmly against electromagnetic cores 20. Since neither armature door-plate 25A nor armature drawer-plate 25B cannot be separated from their respective electromagnetic cores 20, cabinet door 15 and drawer 14A remain closed and locked until the magnetic field is de-energized. When remote transmitter 11 is used to turn the system off, another signal is sent to power supply 12 and the flow of current to electromagnetic cores 20 is discontinued. Without current, the magnetic field is lost between electromagnetic cores 20 and their corresponding armature plates (armature-door plate 25A or armature drawer-plate 25B), which allows cabinet door 15 or drawer 14A to be opened.

As shown in FIGS. 1 and 2, electromagnetic door-lock assembly 16A is composed of several parts held together by clamp 24. Clamp 24 holds electromagnetic core 20 fastened securely onto base 22's rounded protruding edge. Base 22 is attached to front cabinet frame 13 with four wood screws 23. Clamp 24 and base 22 are designed to allow adjustment of electromagnetic core 20's position in reference to armature drawer-plate 25B facilitating the installation of electromagnetic core 20 in a wide range of positions and locations on cabinet frame 13 of varying cabinet styles. When properly positioned on base 22 and when cabinet door 15 is in the closed position, electromagnetic core 20 is situated in a location where contact is reached between armature door-plate 25A and electromagnetic core 20. Armature door-plate 25A is attached to cabinet door 15 with flat head plate screw 26. The hole in armature door-plate 25A is counter sunk, counter bored, and drilled out to allow the head of plate screw 26 to be below the surface of armature door-plate 25A and have a loose fit. This allows armature door-plate 25A to “float” on plate screw 26 so that a flat contact between armature door-plate 25A and electromagnetic core 20 is ensured when cabinet door 15 is in the closed position.

As shown in FIGS. 1 and 3, electromagnetic drawer-lock assembly 16B is composed of several parts held together by clamp 24. Clamp 24 holds electromagnetic core 20 fastened securely onto base 22's rounded protruding edge. Base 22 is attached to angle bracket 30 by bracket screws 31A and bracket nuts 31B. Angle bracket 30 is attached to cabinet side panel 17 with four wood screws 23. Clamp 24 and angle bracket 30 are designed to allow adjustment of electromagnetic core 20's position in reference to armature drawer-plate 25B facilitating the installation of electromagnetic core 20 in a wide range of positions and locations on side panel 17 of varying cabinet styles. When properly positioned on base 22 and when drawer 14A is in the closed position, electromagnetic core 20 is situated in a location where contact is reached between armature drawer-plate 25B and electromagnetic core 20. Armature drawer-plate 25B is attached to drawer backboard 14B with flat head plate screw 26. The hole in armature door-plate 25B is counter sunk, counter bored, and drilled out to allow the head of plate screw 26 to be below the surface of armature drawer-plate 25B and have a loose fit. This allows armature drawer-plate 25B to “float” on plate screw 26 so that a flat contact between armature drawer-plate 25B and electromagnetic core 20 is ensured when drawer 14A is in the closed position.

As seen in FIGS. 2 and 3, each electromagnetic core 20 is connected to power supply 12 using double insulated twisted pair cross-connect wire 21. Wire 21 from electromagnetic cores 20 to power supply 12 is located in a protected position within cabinet assembly 10's framework. Power supply 12 is powered by a 100-240 Volt A/C receptacle or an alternative power source; a voltage converter changes the high voltage A/C to a low voltage D/C. A single power supply 12 can provide power for up to thirty (30) electromagnetic cores 20, all thirty (30) turning on and off at the same time. The remote controlled power supply 12 receives its on-off signal from remote transmitter 11 which simultaneously controls all electromagnetic cores 20 connected to power supply 12.

Conclusion, Ramifications, and Scope

Accordingly, the reader will see that the electromagnetic locking system for cabinet doors and drawers of this invention can be used to lock and unlock multiple cabinet doors and drawers easily and conveniently, and allows the user great control over when the cabinets will be locked or unlocked and for how long. In addition, the locking system can be easily installed onto practically any type of cabinet door or drawer and causes no wear and tear damage once in use. Furthermore, the locking system has the additional advantages in that

it permits a wide range of installation positions with its versatile hardware

it permits for the system to be expanded over time simply by adding more locking assemblies, as necessary

it permits the use of alternate power sources (like battery back-ups, etc.)

it permits the use of alternate actuators (like coded cards, numeric keypads, timers, etc.)

Although the description above contains many specificities, these should not be construed as limiting the scope of the invention but as merely providing illustrations of some of the presently preferred embodiments of this invention. Thus, the scope of the invention should be determined by the appended claims and their legal equivalents, rather than by the examples given.

I claim:

1. A system for locking and unlocking cabinet doors and drawers comprising of a single power supply for a plurality of locking assemblies
plus a single external means of turning on and off said power supply,
plus a means of connecting said power supply too said plurality of locking assemblies,
plus a means of attaching said locking assemblies to the frame of cabinets with openings that can be enclosed with cabinet doors or drawers,
plus a matching armature plate per each said locking assembly attached to an inner face of said cabinet doors or drawers,
plus a means of attaching said armature plates to said inner face of said cabinet doors or drawers
whereby actuating said external means of turning on and off said power supply actuates said power supply which in turn actuates said locking assemblies
whereby actuating said locking assemblies while said armature plates and said locking assemblies are in contact induces an electromagnetic force that impedes separation of said locking assemblies and said armature plates
whereby said cabinet doors or drawers with said locking assemblies and said armature plates installed are prevented from being opened until said external means of turning on and off said power supply is actuated to turn off said power supply
whereby the user of said means of turning on and off said power supply controls the access into said cabinets with said locking assemblies and armature plates installed.

2. A system as set forth on in claim 1 wherein said locking assemblies include an electromagnetic core
whereby said electromagnetic cores induce a magnetic field attracting said armature plates when actuated.

3. A system as set forth on in claim 1 wherein the means of attaching said locking assemblies to said cabinet frames can be adjusted
whereby installation of said locking assemblies is possible onto cabinets or enclosures of varying construction, style, framework, etc.

4. A system as set forth on in claim 1 wherein said armature plates are attached to said cabinet doors or drawers in such a manner that allows said armature plates to remain aligned and in full contact with said locking assemblies even when shearing force is applied to said cabinet door or drawer with the intention of opening the said door or drawer
whereby contact between said locking assembly and said armature plate is not disrupted
whereby the electromagnetic force between said locking assembly and said armature plate is not disrupted
whereby said cabinet door or drawer remains closed.

5. A system as set forth on in claim 1 wherein said means of turning on and off said power supply may include but are not limited to a wireless remote control, a switch, keypad, etc.
whereby actuating said single control unit actuates a plurality of locking assemblies (and therefore, a plurality of cabinet doors or drawers) simultaneously.
